(19) United States
(12) Patent Application Publication
(10) Pub. No.: US 2026/0236404 A1
(43) Pub. Date: Aug. 13, 2026

(54) FILE ENCRYPTION IN AN EMULATED ENVIRONMENT USING INPUT OUTPUT PROCESSORS

(71) Applicant: Unisys Corporation, Blue Bell, PA (US)

(72) Inventors: Michael RIESCHL, Blue Bell, PA (US); Robert BERGERSON, Blue Bell, PA (US); Kerry LANGSFORD, Blue Bell, PA (US); Carl CRANDALL, Blue Bell, PA (US); Brian WEGLEITNER, Blue Bell, PA (US); Brian LEPAGE, Blue Bell, PA (US); James HEIT, Blue Bell, PA (US); Thomas DEVRIES, Blue Blell, PA (US); Jane MUCCIO, Blue Bell, PA (US)

(21) Appl. No.: 19/051,919

(22) Filed: Feb. 12, 2025

(51) Int. Cl. G06F 12/14

(52) U.S. Cl. CPC G06F 12/1408; G06F 2212/1052

(57) ABSTRACT

In various examples, cryptographic storage operations in a first computing environment a performed based on cryptographic information and offset information associated with a data object of an application. For example, a request for a new data object causes cryptographic information and offset information for the data object to be determined. A cryptographic input output (IO) processor then encrypts and stores the data object based on the cryptographic information and offset information.

### BACKGROUND

In various types of networked computing environments, data security is an important concern. For example, encryption of data both in transit and at rest is used to maintain privacy and security for various computer systems. One example of a commonly used cryptographic algorithm is the Advanced Encryption Standard (AES), which is a symmetric cipher that can be used to safely encrypt data. Furthermore, cryptographic algorithms such as AES are being used more frequently as organizational security requirements dictate. However, encryption and decryption operations required by these cryptographic algorithms often cause a noticeable degradation in computer system performance such as on heavily used high-capacity computer systems (e.g., server computer systems, mainframes, cloud computing systems, etc.). Furthermore, users want the benefits and security of these cryptographic algorithms while data is in “motion,” such as transaction processing, and while the data is at “rest,” such as file storage and tape storage. Furthermore, this requirement is so important that software solutions are needed to ensure that data is secure both in motion and at rest.

### SUMMARY

Embodiments described herein are directed to enabling a computing environment secure data (e.g., files) by at least causing a cryptographic input output (IO) processors to perform cryptographic operations. Advantageously, in various embodiments, the systems and methods described are directed towards emulating a computing environment that secures data in a storage device by at least tracking cryptographic information (e.g., key name, key version, encryption algorithm etc.) and relative offsets associated with the data to enable encryption and decryption of portions of a data object (e.g., files) with processing the entire data object. Some computing environment, for example, include a master file directory or similar data structure that is modified to include cryptographic information that is provided to a cryptographic IO processors to encrypt data and cause encrypted data to be stored in a storage device and/or obtain encrypted data from the storage device and decrypt the data. In various embodiment, a key management service (KMS) or other cryptographic hardware is used to maintain cryptographic keys used to encrypt and decrypt data object.

In various embodiments, the computing environment (e.g., a guest computing environment) has access to logical storage (e.g., a logical disk drive) that is emulated using a physical server computer system. For example, the cryptographic IO processors obtain IO requests from the computing environment including cryptographic information and relative offset information (e.g., a offset relative to the start of a data object), perform encryption and decryption operations, and provide storage requests to the underlying physical server computer system supporting the computing environment. Therefore, the systems and methods described are capable encrypting and/or decryption a portion of the data object without the need to process the entire data object.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a cryptographic library provides a first computing environment with access to cryptographic hardware of a second computing environment, in accordance with at least one embodiment.

FIG. 3 depicts an environment in which cryptographic input output (IO) processor perform storage operations, in accordance with at least one embodiment.

FIG. 4 depicts an environment in which cryptographic input output (IO) processor perform storage operations, in accordance with at least one embodiment.

FIG. 5 depicts an example process flow for determining access to a data object, in accordance with at least one embodiment.

FIG. 6 depicts an example process flow for maintaining cryptographic information and offset information associated with a data object in a master file directory (MFD), in accordance with at least one embodiment.

FIG. 7 depicts an example process flow for performing a cryptographic storage operation on a portion of a data object, in accordance with at least one embodiment.

FIG. 8 provides a block diagram of an exemplary distributed computing environment suitable for use in accordance with at least one embodiment.

FIG. 9 is a block diagram of an exemplary computing environment suitable for use in implementations of the present disclosure.

### DETAILED DESCRIPTION

Embodiments described herein generally relate to encryption of data objects (e.g., files) of a computing environment on a storage device (e.g., at “rest”) where encryption and/or decryption operations are performed on a portion of the data object without the need to perform the operations on the entire data object. Advantageously, in one example, an application executed within the computing environment is able to update a file without decrypting and re-encrypting the entire file. In various embodiments, a master file directory (MFD) stores cryptographic information associated with data object stored by the computing environment, during storage operation, the cryptographic information is retrieved from the MFD and provided to a cryptographic input output (IO) processor to execute the storage and encryption operations. For example, the cryptographic information include a key name, key version, relative offset, initialization vector, or other information that is used by the cryptographic IO processor. Furthermore, in various embodiments, the computing environment stores data on a logical storage device that is emulated using physical hardware that the cryptographic IO processor communicates with to perform the storage operations (e.g., reading and writing encrypted data).

Some conventional solutions secure data at rest at the media and/or storage device level. For example, full-disk encryption (FDE) is a method for protecting sensitive data at the media and/or storage device level by encrypting all of the data stored within the physical hardware. However, these solutions often rely on a single cryptographic key to encrypt all of the data and do not allow for encryption and/or decryption of a portion of a data object. Furthermore, as more and more data is exposed in networked environments, the data is at risk during transmission as FDE only secures data at rest (e.g., at the storage level). This combination of factors creates several problems, as the need to maintain data security is networked environments increases.

For example, the Advanced Encryption Standard (AES) is a commonly used cryptographic algorithm to protect data in a networked computing environment. Furthermore, organizational security requirements often dictate that cryptographic algorithms such as AES be used. However, as mentioned above, encryption and decryption operations at a storage system level risks data by using only one cryptographic key, can be ineffective at securing data during transmission, and does not allow for operations to be performed on less than the entire data object. Users of these systems want the benefit of these cryptographic algorithms without these particular limits.

Aspects of the technology described herein provide a number of improvements over existing technologies. For instance, the cryptographic IO processor allows users of the computing environment to encrypt different portions of a data object with different cryptographic key information. In this manner, the cryptographic IO processor is able to encrypt and/or decrypt portions of the data object when reading or writing the data object from a media and/or storage device in accordance with an embodiment. As mentioned above, in various embodiments, the computing environment includes cryptographic information in the MFD as well as offset information associated with data objects. As such, in one example, once an initialization vector is determined, the initialization vector is combined with a relative a relative offset associated with a block of data within a data object enabling portions of the data object to be encrypted and/or decrypted without modifying the entire data object.

Furthermore, in an embodiment, the MFD maintains user information associated with data objects maintained by the computing environment. For example, an application executed within the computing environment is assigned as the owner of a particular data object and encryption and/or decryption of the particular data object is limited to the owner (e.g., the application). In addition, in some embodiments, a key management service (KMS) maintains the cryptographic key and restricts access to the cryptographic key to authorized users (e.g., an operating system of the computing environment).

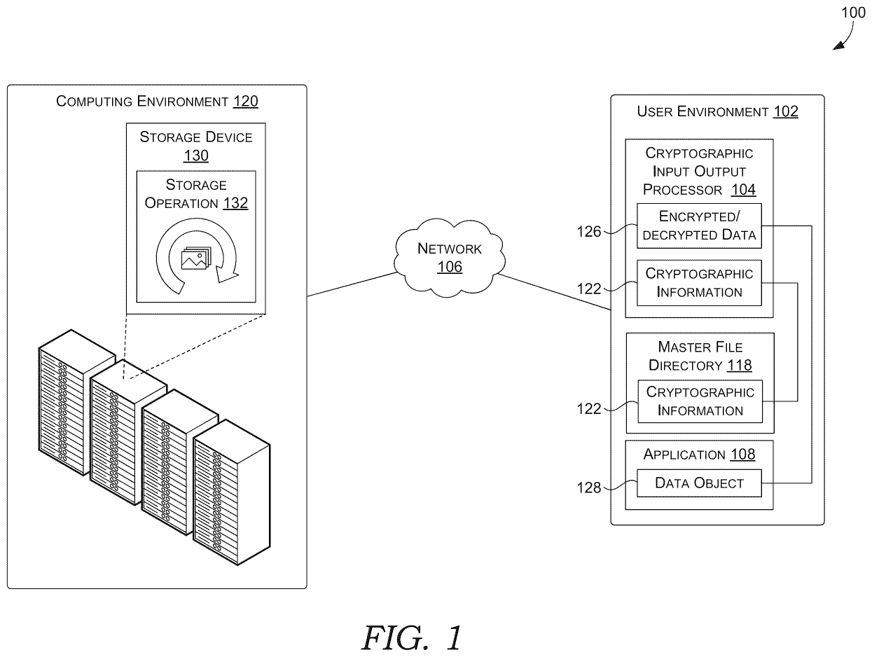

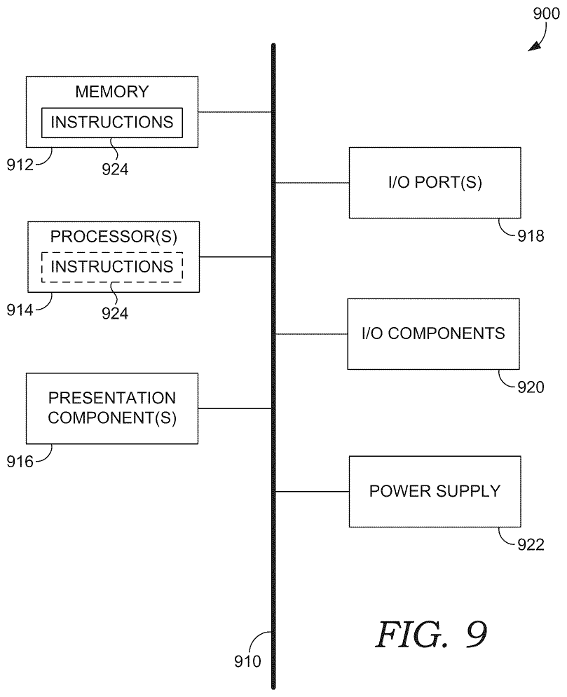

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user environment 102, a computing environment 120, a cryptographic input output (IO) processor 104, an application 108, a master file directory (MFD) 118, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure.

By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the user environment 102 and/or the computing environment 120 includes multiple server computer systems cooperating in a distributed environment to perform the operations described in the present disclosure.

The user environment 102 can be any type of computing device capable of being operated by an entity (e.g., individual or organization) and communicating data (e.g., via the cryptographic IO processor 104) for execution of a storage operation 132 by a storage device 130 of the computing environment 120. The user environment 102, in various embodiments, has access to or otherwise maintains a data object 128 of the application 108 that is used to perform the storage operation 132. For example, the application 108, executing within the user environment 102, generates the data object 128. The data object 128 includes a file, a data structure, a document, a record, an archive, or other structured or unstructured data associated with the application 108 that is capable of being stored in the storage device 130. In various embodiments, the application 108 is executed within the user environment 102, which is an emulated computing environment (e.g., guest operating system) supported by the computing environment 120 (e.g., host operating system).

In some implementations, user environment 102 and/or computing environment 120 is implemented using the type of computing device described in connection with FIG. 9. By way of example and not limitation, user environment 102 and/or computing environment 120 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, a server computer system, any combination of these delineated devices, or any other suitable device.

In an embodiment, the user environment 102 can include one or more processors and one or more computer-readable media that are emulated by the computing environment 120. For example, the cryptographic IO processor 104 is emulated using hardware of the computing environment 120. Furthermore, in some examples, the user environment 102 storages the data object 128 in a logical storage devices which is emulated by the storage device 130. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user environment 102, the cryptographic IO processor 104, and/or the computing environment 120. For example, the application 108 transmits the data object 128 to the cryptographic IO processor 104 via an emulated processor (e.g., instruction processor [IP]). Continuing this example, the cryptographic IO processor 104 then generates encrypted/decrypted data 126 based on cryptographic information 122 included in the MFD 118 and provides the encrypted/decrypted data 126 to the computing environment 120 for storage within the storage device 130. In some implementations, the application 108 comprises a web application, which can run in a web browser, and can be hosted at least partially on the server-side of the operating environment 100. In addition, or instead, the application 108 can comprise a dedicated application, such as an application being supported by the user environment 102 and the cryptographic IO processor 104. In some cases, the application 108, the cryptographic IO processor 104, and/or other components of the user environment 102 described below are integrated into the operating system (e.g., as a service, application programming interface [API], etc.).

For cloud-based implementations, for example, the application 108 is utilized to interface with the functionality implemented by the computing environment 120 to execute the storage operation 132 through the cryptographic IO processor 104. In some embodiments, the components, or portions thereof, of the cryptographic IO processor 104 are implemented on the user environment 102 or other systems or devices. Thus, it should be appreciated that the cryptographic IO processor 104, in some embodiments, is provided via multiple devices arranged in a distributed environment that collectively provide the functionality described herein. Additionally, other components not shown can also be included within the distributed environment.

Furthermore, as described below, in various embodiments, the components of the user environment 102 are emulated or otherwise visualized by the computing environment 120 or component thereof, such as an operating system. The terms “emulated,” “emulation,” “virtual,” and “virtualized” do not imply that a particular component does not exist. Rather, these terms refer to a computer component such as a machine, network, storage system, computer, processor, or the like, that is created using software on a physical computer (or a physical distributed computing system like the cloud) in order to emulate the functionality of another separate physical computer component, such as a machine, network, storage system, computer, processor, or the like. Thus, the emulated physical component is referred to as a virtual component.

As illustrated in FIG. 1, the application 108 and/or operating system executing in the user environment 102 utilizes the cryptographic IO processor 104 to perform cryptographic operations on the data object 128, in accordance with various embodiments. For example, the cryptographic IO processor 104 is provided as a service, API, or other component of an operating system of the user environment 102. As described below, in various embodiments, the cryptographic IO processor 104 generates the encrypted/decrypted data 126 based on the cryptographic information 122 that is provided to the computing environment 120 and, as a result of being received by the computing environment 120, causes the computing environment 120 to perform the storage operation 132. For example, the cryptographic information 122 is used to determine cryptographic key for encrypting or decrypting the data object 128 to generate encrypted/decrypted data 126.

Furthermore, as mentioned above, in various embodiments, the computing environment 120 emulates, virtualizes, or otherwise provides one or more components of the user environment 102. For example, the computing environment 120 includes an operating system or other executable code that, as a result of being executed by one or more processors of the computing environment 120, provides the user environment 102 with an emulated processor, input/output device (e.g., cryptographic IO processor 104), storage (e.g., logical storage device), memory, or other computer component. In an embodiment, the instructions are embodied by an emulation application that emulates the operations and/or instruction architecture of a processor such as the IP. In one example, the emulation application is referred to as a single application for simplicity, but its functionality can be embodied by one or more applications in practice. In various embodiments, the emulation application includes any application capable of emulating a processor and facilitating the exchange of information between the computing environments such as the user environment 102 and the computing environment 120.

In various embodiments, the operating system of the user environment 102 obtains an operation, call, or other instruction from the application 108 and executes a machine instruction to the emulated processor (e.g., the IP) and causes a cryptographic library and/or the cryptographic IO processor 104 to generate the encrypted/decrypted data 126. In such embodiments, the emulator, operating system, or other component of the computing environment 120 obtains and/or extracts information in the MFD 118 and causes hardware of the computing environment 120, such as a processor, to perform one or more cryptographic operations. For example, the application 108 is assigned user identification information and any data object that is created by the application 108 is associated with the user identification information. Continuing this example, in response to the user identification information being associated with or otherwise setup to encrypt data (e.g., a setting of the operating system), the operating system causes data object generated by the application 108 to be encrypted prior to storage in the storage device 130.

In various embodiments, the user environment 102 and/or the operating system causes all data objects to be encrypted prior to storage in the storage device 130. In yet other embodiments, encryption is determined per data object. For example, the operating system or other component of the user environment 102 can encrypt a portion of the data objects generated by the application 108.

In various embodiments, the MFD 118 a central directory and/or data structure that contains references and information corresponding to all other directories and data objects maintained by the user environment 102. For example, the MFD 118 includes various types of information such as file names, file version information, file owner information, location information, size information, or other information used to create, edit, delete, update, or otherwise modify data objects. Continuing this example, the MFD 118 also includes cryptographic information such as key names, key version information, encryption algorithm information, initialization vector information, or other information used to perform encryption and/or decryption operations.

Furthermore, in various embodiments, the MFD 118 include offset information corresponding to a location of a portion (e.g., data block or word within the file) of the data object relative to the start of the data object. For example, an IO buffer is used during read and/or write operations to store data blocks and the offset information is determined relative to the beginning of the disk sector of the storage device 130 or other location information of the media used to store the data. Furthermore, in various embodiments, this offset information is used to generate an initialization vector used during the cryptographic operation such that portions of the data object can be encrypted or decrypted without performing the operation on the entire data object.

In one example, the initialization vector is determined based on the following equation:

$$IV = {IV}_{f} ⊕ {RO}_{s′}$$

where IV_{f} is the initialization vector for the data object (e.g., files) and ROₛ is the relative offset from the beginning of the disk sector for a particular portion (e.g., word) of the data object. In various embodiments, the disk sectors correspond to disk sectors of a logical disk of the user environment 102.

Furthermore, in various embodiments, in response to a data object or new version of an existing data object being created the data object information, cryptographic information, and/or offset information is cataloged, recorded, otherwise maintained in the MFD 118. In addition, in some examples, each time a data object or new version of an existing data object is created, the operating system and/or other component of the user environment 102 determines whether the data object should be encrypted.

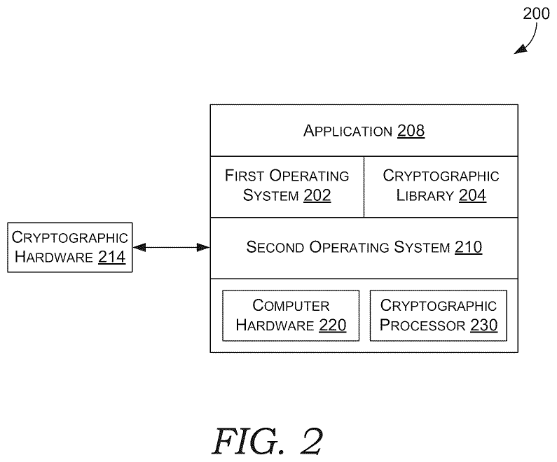

In various embodiments, during encryption or decryption operations, the operating systems obtains the cryptographic key from a key management service (KMS), as described in greater detail in connection with FIG. 2, and generates an cryptographic information for the data object (e.g., initialization vector, cryptographic key name, cryptographic key version, etc.). In one example, the cryptographic key is stored in a memory location that only the operating systems and/or the cryptographic IO processor 104 can access. Continuing this example, the cryptographic IO processor 104 reads and writes data from the storage device 130 to a buffer and/or memory location within the user environment 102 and performs the cryptographic operations within the buffer and/or memory location. Furthermore, in some embodiments, the cryptographic IO processor 104 maps storage location of data objects in the logical storage to corresponding storage locations within the storage device 130. For example, data objects, such as files, are not contiguous within the storage device 130 and/or the logical storage but are spread across a plurality of disks of the storage device 130 and/or a plurality of different storage devices. Continuing this example, the cryptographic IO processor 104 performs various operations such as the logical disk sectors to physical disk sector conversion, translation, mapping, and/or recording as part of the storage operation 132.

In one example, the cryptographic IO processor 104 or other component of the user environment 102 (e.g., the operating system, emulated processor, etc.) passes or otherwise provides the encrypted/decrypted data 126 to the emulator or other component of the computing environment 120 (e.g., host operating system). In various embodiments, the emulator causes the computer hardware (e.g., storage device 130) to perform the storage operation 132.

In addition, the application 108, in an embodiment, stores the data object 128 and other information used to execute the storage operation 132 in a buffer or other area of memory that is read or otherwise accessed by the cryptographic IO processor 104 to generate the encrypted/decrypted data 126. In one example, in response to obtaining the encrypted/decrypted data 126, the computing environment 120 encrypts the buffer and returns a status in the encrypted/decrypted data 126 to the user environment 102 indicating a status of the storage operation 132 (e.g., completed, incomplete, error, etc.).

In various embodiments, the MFD 118 stores a plurality of bits fields (e.g., a 28 word sector) that contains information associated with a data object. In one example, a set of bits represent encryption information such as an encryption status (e.g., encrypted or unencrypted), a cryptographic key version, a cryptographic key, and an initialization vector. In addition, in various embodiments, the data maintained in each field (e.g., the set of bits representing the encryption information) is used to obtain the cryptographic information from the KMS. For example, the cryptographic key name and cryptographic key version information are included in a request to the MKs to obtain the cryptographic key. In other embodiments, the MFD 118 stores the data directly. In one example, the initialization vector for a particular data object is stored in the corresponding bit fields in the MFD 118.

FIG. 2 shows a block diagram of environment 200 in which a cryptographic library 204 provides access to a cryptographic processor 230 in accordance with at least one embodiment. In the illustrated example, a first operating system 202 (e.g., an operating system executing within a first computing environment) is executing on emulated processors (e.g., IPs) for supporting execution of an application 208. In various embodiments, a host system of FIG. 2 (e.g., the server computer system executing the component illustrated) includes computer hardware 220 (e.g., processors, memory, storage, etc.) that is used to support or otherwise execute a second operating system 210 that provides the emulated processors.

In various embodiments, the second operating system 210 has access to or other otherwise connected to cryptographic hardware 214. For example, the cryptographic hardware 214 includes a KMS connected to the computer hardware 220. In addition, the first operating system 202, in various embodiments, communicates with the cryptographic hardware 214 through a connector provided by the second operating system 210. In one example, the second operating system 210 emulates the connection with the cryptographic hardware 214 and communicates requests from the first operating system 202 to the cryptographic hardware 214. Furthermore, in various embodiments, communications (e.g., requests) to the cryptographic hardware 214 are authenticated. For example, the first operating systems 202 is assigned privileges and/or access controls to export a cryptographic key, create new cryptographic key, rotate a cryptographic key, or cause the cryptographic hardware 214 to perform other operations based on a certificate of authentication provided to the cryptographic hardware 214 which is stored the second operating system 210 (e.g., the emulated connector to the cryptographic hardware 214).

In an embodiment, the first operating system 202 and the cryptographic hardware 214, through the second operating system 210, communicate using an input queue and an output queue. For example, the first operating system 202 will queue requests on the input channel and be notified when there is a response on the output channel. In addition, cryptographic keys or other cryptographic information obtained from the cryptographic hardware 214 or other location (e.g., from the MFD 118 described above in connection with FIG. 1), in various embodiments, is maintain in memory and/or cache to limit access. For example, as a result of an encrypted file being cataloged and/or assigned, cryptographic information including the key name and version is obtained from the MFD and stored in the cache. Continuing this example, the first operating system 202 the obtains initialization vectors from the cryptographic hardware 214. In various embodiments, encrypted files are encrypted with a unique initialization vector that is obtained and/or generated as a result of the file being cataloged and/or created. Furthermore, in various embodiments, the cryptographic key version allow for rotation of the cryptographic key.

Returning to the example above, the MFD provides the cryptographic information (e.g., key names, key version, initialization vector, encryption algorithm, etc.) to the cryptographic IO processors to enable the cryptographic IO processors to obtain the key from the KMS and causes the cryptographic processor 230 to perform the encryption operations. In some embodiments, the cryptographic processor 230 includes a software implementation of the cryptographic operations provided by executable code within the cryptographic library 204.

In various embodiments, the first operating system 202 is executing in a child partition of the second operating system 210. For example, virtualization service client is a program that executes in a computer system emulator (e.g., a virtual machine or software container) on the host system and coordinates with a virtualization service provider to request and obtain access to the computer hardware 220, storage, network, or other resources of the host system for the computer system emulator. In various embodiments, the first operating system 202 and/or application 208 utilizes computer hardware 220 that is provided by the second operating system 210 or component thereof, such as the virtualization service provider executing in a parent partition (e.g., the second computing environment). For example, the first operating system 202 communicates with the second operating system 210 using a virtual memory bus, input output processor (e.g., cryptographic IO processor 104 described above in connection with FIG. 1), or other virtualized computer hardware to process requests generated by the first operating system 202, cryptographic library 204, and/or application 208. In various embodiments, a hypervisor executes between computer hardware 220 and one or more operating systems that run in partitions (e.g., a first computing environment and a second computing environment). For example, the hypervisor creates and manages isolated execution environments (e.g., partitions), and provides the isolated execution environments with a portion of computer hardware 220, such as memory, devices, and processor cycles.

Furthermore, in various embodiments, the computer hardware 220 includes a cryptographic processor 230. For example, the cryptographic processor 230 includes a separate processor of the computer hardware 220, such as a central processing unit (CPU) or GPU, that is used to perform cryptographic operations. In addition, the host system, in the example illustrated in FIG. 2, includes cryptographic hardware 214. In one example, the cryptographic hardware 214 includes a hardware security module (HSM) and/or KMS that is a hardened, tamper-resistant hardware device that secures cryptographic processes by generating, protecting, and managing keys used for encrypting and decrypting data and creating digital signatures and certificates. In one example, the set key operation of the cryptographic library 204 causes the cryptographic hardware 214 to generate cryptographic keys for use in encrypting and decrypting data maintained by the application 208.

In various embodiments, the first operating system 202 executes using a plurality of emulated processors. For example, a set key operation, an encrypt operation, and a decrypt operation generated by the cryptographic library 204 can be provided separate emulated processors. Continuing this example, once an operation is provided to a particular emulated processor, as described above, the operation is bound to the emulated processor and corresponding physical processor of the computer hardware 220.

In various embodiments, the second operating system 210 maintains the cryptographic keys in memory. For example, the cryptographic hardware 214 is emulated by the second operating system 210. Continuing this example, the second operating system 210 stores the cryptographic keys and/or other data used to perform the cryptographic operations in a memory structure. In other examples, processing the cryptographic operations is done without the use of the cryptographic hardware 214.

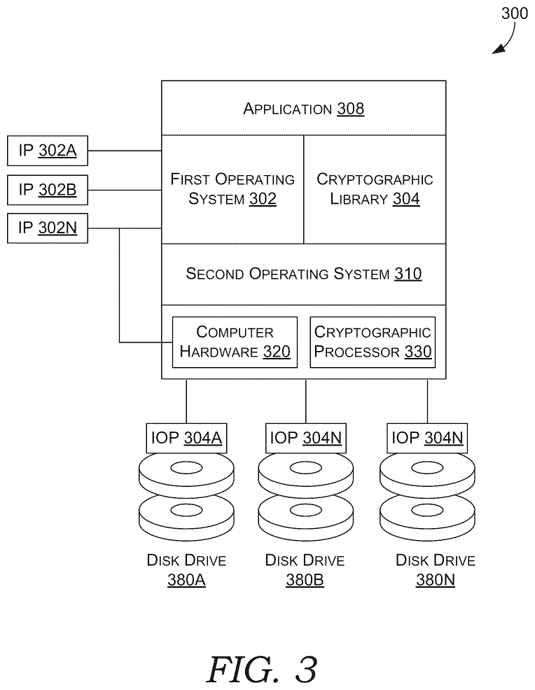

FIG. 3 shows a block diagram of environment 300 in which an application 308 stores encrypted data objects in a plurality of disk drives 380A-380N in accordance with at least one embodiment. In the illustrated example, a first operating system 302 (e.g., an operating system executing within a first computing environment) is executing on emulated processors IPs 302A-302N for supporting execution of the application 308. In various embodiments, a host system of FIG. 3 (e.g., the server computer system executing the component illustrated) includes computer hardware 320 (e.g., processors, memory, storage, etc.), disk drives 380A-380N, a cryptographic processor 330, and cryptographic IP processors (IOPs) 304A-304N that are used to support or otherwise execute a second operating system 310, the first operating system 302, and the application 308 that provides the emulated processors.

In various embodiments, the first operating system 302 establishes communication with the IOPs 304A-304N. For example, the first operating system 302 transmits a packets to a pre-defined memory location. Continuing this example, the first operation system 302 transmits IO request as packets of data in a queue associated with one or more IOPs 304A-304N, the IOP executing the storage operation then returns a status to the first operating system 302 (e.g., a queue entry on a status queue). Furthermore, in various embodiments, the IOPs 304A-304N utilize the cryptographic library 304 and/or the cryptographic processor 330 to perform encryption and/or decryption operations. For example, the cryptographic library 304 includes a executable code that, as a result of being executed by the IPs 302A-302N and/or the computer hardware 320, cause the IPs 302A-302N and/or the computer hardware 320 to encrypt data objects of the application 308. Continuing this example, data associated with data objects of the application 308 are passed to the IOPs 304A-304N through a buffer or other memory accessible to the first operating system 302. Furthermore, in some examples, the cryptographic library 304 implements various encryption algorithms such advance encryption standard (AES) 256.

In various embodiments, to enable transparent file encryption and performance of the IOPs 304A-304N, the file information in each disk sector (e.g., a 504 byte sector of a logical partition) is encrypted separately. In addition, in some embodiments, a portion of the disk sector (e.g., the last 8 bytes) contains a checksum of the initialization vector prefixed to clear text data (e.g., 520 bytes sector). For example, including the initialization vector in the checksum ensures two disk sectors of equal clear text data will not have equal checksums based on different initialization vectors. Continuing this example, in response to a request to a decrypt data (e.g., a read IO request), the checksum of the decrypted data will be recomputed and compared to portion of the disk sector (e.g., the last 8 bytes).

In various embodiments, the IOPs 304A-304N communication with the disk drives 380A-380N over a network. For example, the IOPs 304A-304N communicate with the disk drives 380A-380N using a network connection, service, application programming interface (API), or other component of the second operation system 310. Furthermore, although disk drives 380A-380N are illustrated in FIG. 3, other storage media such as tapes, solid state drives, or media suitable for storing data can be used in connection with the embodiments described.

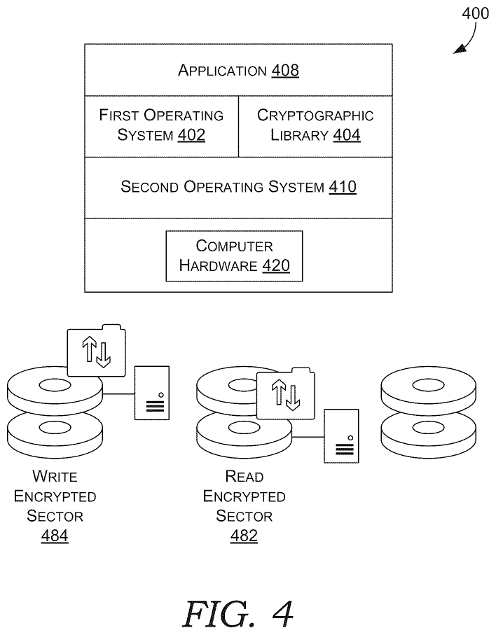

FIG. 4 is shows a block diagram of environment 400 in which a cryptographic library 404 is used to read encrypted sectors 482 and write encrypted sectors 484 in accordance with at least one embodiment. In the illustrated example, a first operating system 402 (e.g., an operating system executing within a first computing environment) is executing on emulated processors (e.g., IPs) for supporting execution of an application 408. In various embodiments, a host system of FIG. 4 (e.g., the server computer system executing the component illustrated) includes computer hardware 420 (e.g., processors, memory, storage, etc.) that is used to support or otherwise execute a second operating system 410 that provides the emulated components to the first operating system 402.

As described above, first operating system 402 includes a MFD that indicates or otherwise stores information associated with the application 408. For example, during the read encrypted sectors 482 operation, the MFD is used to determine, among other information, the sector of a logical partition (e.g., logical disk) corresponding to the encrypted data to be read. Continuing this example, a cryptographic IO processor (e.g., the IOPs 304A-304N) determine the correspondence between the logical sector indicated in the MFD and a physical sector or other location information associated with the computer hardware 420.

In various embodiments, cryptographic IO processor, during the read encrypted sectors 482 operating decrypts or otherwise causes the data to be decrypted (e.g., transmitting a command to the cryptographic library 404 to decrypt the data), stores the decrypted data in a buffer or other location accessible to the first operating system 402, and transmits an indication to the first operation system 402 that the data has be decrypted. Furthermore, in some embodiments, during the read encrypted sectors 482 operation that data object is exclusively assigned to the first operating system 402 or other component illustrated in FIG. 4 to ensure that modification are not made to the data object during decryption.

In various embodiments, during the write encrypted sectors 484 operation the first operating system 402 obtain cryptographic information from the MFD and provides the cryptographic information to the cryptographic IO processor. For example, the cryptographic key name, the cryptographic key version, and initialization vector associated with the data object are provided to the cryptographic IO processor to enable the cryptographic IO processor to obtain the cryptographic key and cause the data to be encrypted prior to writing the encrypted data to a storage device. In some embodiments, such as during back-up or copy operations the encrypted data is obtained from the storage device without decrypting the data. Furthermore, as mentioned above, the initialization vector is combined with a relative offset associated with the data object during encryption operations.

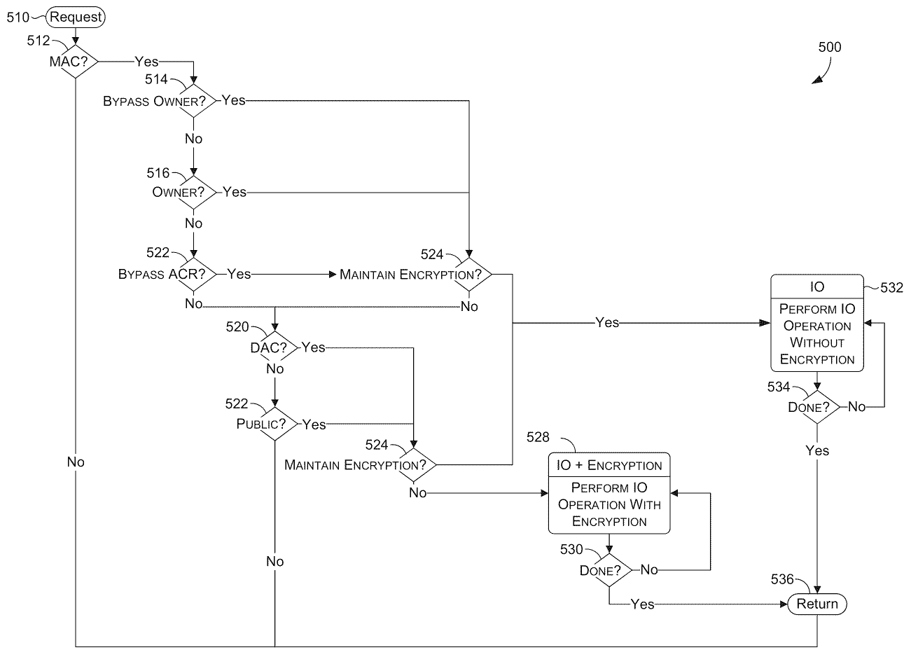

FIG. 5 is a flow diagram showing a method 500 for determine access for cryptographic IO operations in accordance with at least one embodiment. The methods 500, 600, and 700 can be performed, for instance, by the cryptographic IO processor 104 of FIG. 1. Each block of the methods 500, 600, and 700 (described below) and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 510, the system implementing the method 500 obtains a request to perform an IO operation such as reading or writing encrypted data included in a data object associated with an application. As described above in connection with FIG. 1, in various embodiments, an application executing in a first computing environment provides the request to the cryptographic IO processor. In some embodiments, the first operating system obtains cryptographic information and relative offset information from the MFD and provides the cryptographic information and the relative offset the cryptographic IO processor.

At block 510, the system implementing the method 500 determines whether access to the data object is allowed based on mandatory access controls (MAC). For example, as described above, the first operating system determines is the user identification information associate with the application is allowed to access the data object based on the MAC maintained by the first operating system. If access is not allowed (e.g., the MAC does not include the user identification information associate with the application corresponding to the data object), the system implementing the method 500 continues to block 536 and returns as response. For example, the first operating system returns an error to the application indicating that access to the file is not allowed based on the MAC.

At block 514, the system implementing the method 500 determines if the data object is public. For example, public data object are accessible to any application that passed the MAC requirement. At block 528, if the file is public, the system implementing the method 500 performs the IO operating with encryption. In one example, as described above, backup and/or copy operations are performed on data without decrypting the data. At block 530 the system implementing the method 500 determines if the IO operation is done. If the operation is not done, the system implementing the method 500 returns to block 528. If the operation is done, the system implementing the method 500 determines continues to block 536.

In various embodiments, at block 514, the system implementing the method 500 continues to block 516 to determine if the user information indicates the application is the owner of the data object. If the user information indicates the application is the owner, the system implementing the method 500 continues to block 528. If the user information indicates the application is not the owner, the system implementing the method 500 continues to block 518 to determine whether the application can bypass the owner information. For example, some operations such as copy and backup operations are allowed to bypass the owner information associated with the data object. Continuing this example, the application can access the encrypted data, but cannot decrypt the data (e.g., does not have access to the cryptographic information)—in order to be able to move, copy, or otherwise transmit the data in an encrypted format.

At block 520, the system implementing the method 500 determines whether the data object is private. For example, if the data is private, even if the application is allowed to bypass owner information the data is inaccessible and the system implementing the method 500 continues to block 536. If the data object is not private, the system implementing the method 500 determines is the access control rules (ACR) can be bypassed. For example, the ACR indicates application that have privileges to bypass the ACD. If the system implementing the method 500 determines that the ACR cannot be bypassed, the system implementing the method 500 continues to block 526 and determines if the discretionary access controls allow the application access to the data object. If the discretionary access controls do not allow the application access to the data object, the system implementing the method 500 continues to block 536. Otherwise, if the discretionary access controls do allow the application access to the data object, the system implementing the method 500 continues to block 528.

Returning to the example above, if the system implementing the method 500 determines that the ACR can be bypassed, the system implementing the method 500 continues block 524 and determines whether encryption can be bypassed. If encryption can be bypassed, the system implementing the method 500 continues to block 528. In other examples, if encryption cannot be bypassed, the system implementing the method 500 continues to block 532 and performs the IO operation without encryption. At block 534 the system implementing the method 500 determines if the IO operation is done. If the operation is not done, the system implementing the method 500 returns to block 532. If the operation is done, the system implementing the method 500 determines continues to block 536.

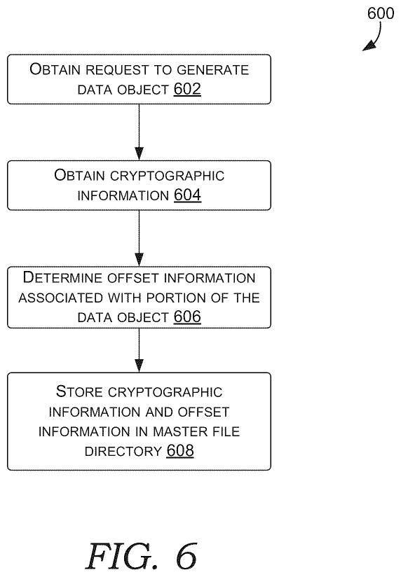

FIG. 6 is a flow diagram showing a method 600 for generating a record in an MFD associated with a data object in accordance with at least one embodiment. The method 600 can be performed, for instance, by the user environment 102 of FIG. 1. As shown at block 602, the system implementing the method 600 obtains a request to generate a data object. As described above in connection with FIG. 1, in various embodiments, an application executing in the user environment generates data that can be stored in a data object such as a file.

At block 604, the system implementing the method 600 obtains cryptographic information. For example, a cryptographic library, KMS, or other component generates a cryptographic key, initialization vector, or other information used to encrypt data. At block 606, the system implementing the method 600 determines offset information associated with a portion of the data object. For example, a relative offset for a portion of the data object include a number of words (e.g., bytes) from the beginning of a file sector. At block 508, the system implementing the method 600 stores the cryptographic information and offset information in the MED.

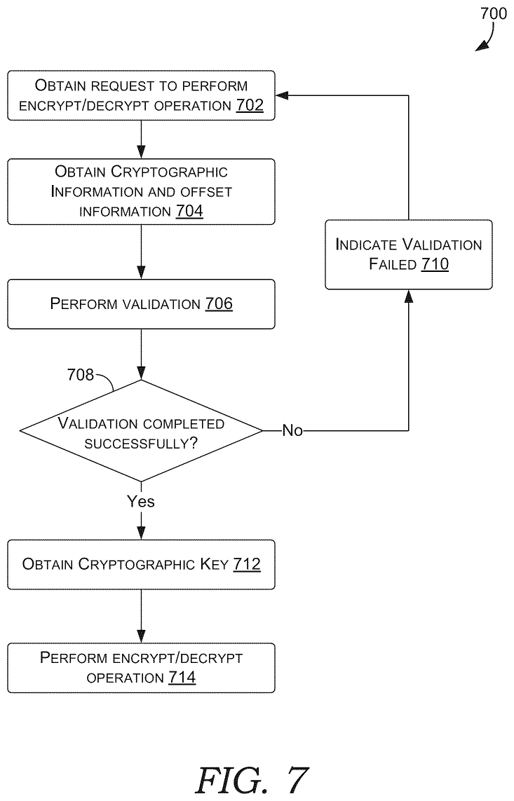

FIG. 7 is a flow diagram showing a method 700 for performing a cryptographic IO operation in accordance with at least one embodiment. The method 700 can be performed, for instance, by the cryptographic IO processor 104 of FIG. 1. As shown at block 702, the system implementing the method 700 obtains a request to perform an encryption and/or decryption operation. For example, an IO request for encrypted data is provided to the cryptographic IO processor. At block 704, the system implementing the method 700 obtains cryptographic information and offset information. For example, the cryptographic IO processor obtains form an operating system and/or MFD information to perform the IO operation and encryption and/or decryption operation. Continuing this example, the offset information is determined based on the start of the data object relative to a logical disk sector.

At block 704, the system implementing the method 700 perform validation. In one example, validation include a plurality of operations to determine if the application has access to the data object and/or cryptographic key. In another example, the validation operations include determine the offset information or other information included in the MFD is valid. At block 708, if the validation operation fails, the system implementing the method 700 continues to block 710 and indicates that the validation fails. At block 708, if validation completes successfully, the system implementing the method 700 continues to block 712 and obtains the cryptographic key. For example, the operating system, as described above, obtains the cryptographic key and stores the cryptographic key in a memory accessible to the cryptographic IO processor. At block 714, the system implementing the method 700 performs the encryption and/or decryption operation.

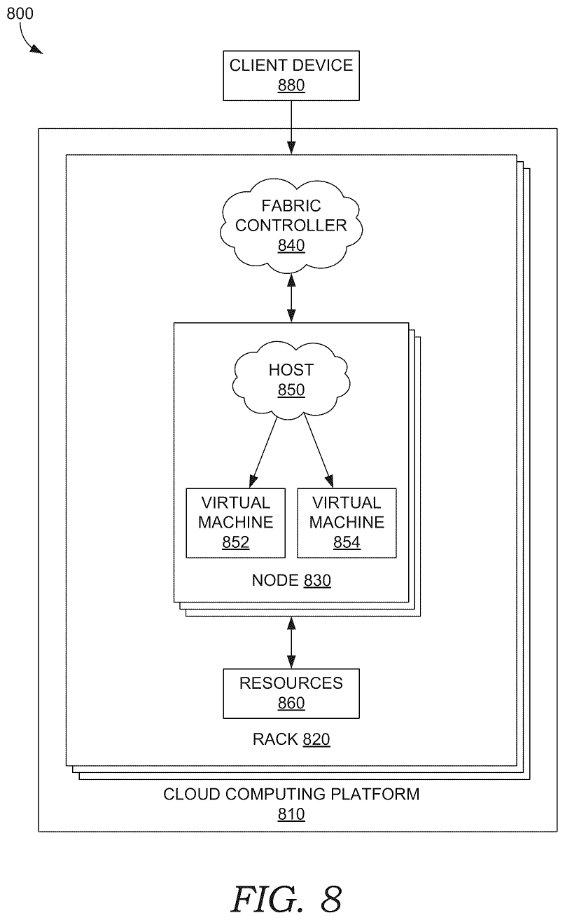

Referring now to FIG. 8, FIG. 8 illustrates an example distributed computing environment 800 in which implementations of the present disclosure may be employed. In particular, FIG. 8 shows a high-level architecture of an example cloud computing platform 810 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 800 that includes cloud computing platform 810, rack 820, and node 830 (e.g., computing devices, processing units, or blades) in rack 820. The technical solution environment can be implemented with cloud computing platform 810 that runs cloud services across different data centers and geographic regions. Cloud computing platform 810 can implement a fabric controller 840 component for provisioning and managing resource allocation, deployment, upgrade, and management of cloud services. Typically, cloud computing platform 810 acts to store data or run service applications in a distributed manner. Cloud computing infrastructure 810 in a data center can be configured to host and support operation of endpoints of a particular service application. Cloud computing infrastructure 810 may be a public cloud, a private cloud, or a dedicated cloud.

Node 830 can be provisioned with host 850 (e.g., operating system or runtime environment) running a defined software stack on node 830. Node 830 can also be configured to perform specialized functionality (e.g., compute nodes or storage nodes) within cloud computing platform 810. Node 830 is allocated to run one or more portions of a service application of a tenant. A tenant can refer to a customer utilizing resources of cloud computing platform 810. Service application components of cloud computing platform 810 that support a particular tenant can be referred to as a multitenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 830, nodes 830 may be partitioned into virtual machines (e.g., virtual machine 852 and virtual machine 854). Physical machines can also concurrently run separate service applications. The virtual machines or physical machines can be configured as individualized computing environments that are supported by resources 860 (e.g., hardware resources and software resources) in cloud computing platform 810. It is contemplated that resources can be configured for specific service applications. Further, each service application may be divided into functional portions such that each functional portion is able to run on a separate virtual machine. In cloud computing platform 810, multiple servers may be used to run service applications and perform data storage operations in a cluster. In particular, the servers may perform data operations independently but exposed as a single device referred to as a cluster. Each server in the cluster can be implemented as a node.

Client device 880 may be linked to a service application in cloud computing platform 810. Client device 880 may be any type of computing device, which may correspond to computing device 900 described with reference to FIG. 9—for example, client device 880 can be configured to issue commands to cloud computing platform 810. In embodiments, client device 880 may communicate with service applications through a virtual Internet Protocol (IP) and load balancer or other means that direct communication requests to designated endpoints in cloud computing platform 810. The components of cloud computing platform 810 may communicate with each other over a network (not shown), which may include, without limitation, one or more local area networks (LANs) and/or wide area networks (WANs).

Having described embodiments of the present disclosure, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and make reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, random access memory (RAM), read-only memory (ROM), electrically erasable programmable read-only memory (EEPROM), flash memory or other memory technology, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, other camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining, from an application executing in a first computing environment, a request to create a data object;
generating a determination to encrypt the data object based on user identification information associated with the application;
in response to the determination, obtaining cryptographic information from a cryptographic hardware in a second computing environment;
determining offset information associated with the data object relative to a logical storage device of the first computing environment;
updating a master file directory (MFD) of the first computing environment based on the cryptographic information and the offset information; and
causing a cryptographic input output (IO) processor to perform a storage operation with the data object based on the cryptographic information and the offset information included in the MFD.

2. The method of claim 1, wherein the cryptographic information includes a cryptographic key name and a cryptographic key version.

3. The method of claim 1, wherein obtaining the cryptographic information from the cryptographic hardware further comprises transmitting, by an operating system of the first computing environment, a request to generate a cryptographic key by the cryptographic hardware.

4. The method of claim 3, wherein the method further comprises storing, by the operating system, the cryptographic key in a memory accessible to the cryptographic IO processor.

5. The method of claim 1, wherein the request to create the data objects further comprises a request to create a new version of the data object.

6. The method of claim 5, wherein obtaining the cryptographic information from the cryptographic hardware further comprises causing the cryptographic hardware to generate a new version of a cryptographic key associated with the data object, where the cryptographic key is indicating in the MFD associated with the data object.

7. The method of claim 1, wherein causing the cryptographic IO processor to perform the storage operation further comprises combing the offset information with an initialization vector included in the cryptographic information.

8. One or more computer storage media storing executable instructions embodied thereon, that, as a result of being executed by a processing device, cause the processing device to perform operations comprising:
obtaining, from an application, a request to create a data object;
determining based on the application to encrypt the data object;
obtaining cryptographic information associated with the data object;
determining offset information associated with at least a portion of the data object and indicating a location relative to a start of the data object within a storage location;
causing the cryptographic information and the offset information to be stored in a data structure associated with the data object;
causing the portion of the data object to be encrypted to generate an encrypted data object; and
causing the encrypted data object to be stored in storage device.

9. The medium of claim 8, wherein the data structure associated with the data object further comprises a master file directory of an operating system.

10. The medium of claim 8, wherein the cryptographic information further comprises at least one of; a cryptographic key, a cryptographic key name, a cryptographic key version, an indication of a cryptographic algorithm, and an initialization vector.

11. The medium of claim 10, wherein causing the portion of the data object to be encrypted further comprises combining the initialization vector with the offset information prior to encrypting the portion of the data object.

12. The medium of claim 8, wherein the cryptographic information is obtained from a key management service executing within a second computing environment distinct from a first computing environment executing the application.

13. The medium of claim 8, causing the portion of the data object to be encrypted further comprises transmitting a request to a cryptographic input output (IO) processor to store the portion of the data object in a logical partition associated with a first computing environment.

14. The medium of claim 13, wherein the request includes the cryptographic information and the offset information.

15. The medium of claim 13, wherein the cryptographic IO processor stores the portion of the data object in a physical storage device.

16. A system comprising:
a memory component; and
a processing device coupled to the memory component, the processing device to perform operations comprising:
obtaining a request to access a portion of a data object associated with an application executed within a first computing environment;
obtaining, from a master file directory associated with the first computing environment, cryptographic information and offset information associated with the portion of the data object; and
causing a cryptographic input output (IO) processor to perform an operation associated with the portion of the data object based on the cryptographic information and the offset information.

17. The system of claim 16, wherein the cryptographic information include a cryptographic key name, a cryptographic key version, and an initialization vector associated with the data object.

18. The system of claim 17, wherein the offset information indicates a location within the data object of the portion of the data object.

19. The system of claim 17, wherein the operation further comprises combing the offset information with the initialization vector.

20. The system of claim 19, wherein the operation further comprises decrypting the portion of the data object without decrypting at least one other portion of the data object.
